(19) United States
(12) Patent Application Publication
(10) Pub. No.: US 2013/0327689 A1
(43) Pub. Date: Dec. 12, 2013

(54) FILTER WITH A BYPASS MECHANISM FOR A HYDRAULIC SYSTEM

(71) Applicant: FORD GLOBAL TECHNOLOGIES, LLC, DEARBORN, MI (US)

(72) Inventors: Michael Georg Figura, Dormagen (DE); Volker Petermann, Cologne (DE)

(21) Appl. No.: 13/914,274

(22) Filed: Jun. 10, 2013

(30) Foreign Application Priority Data
Jun. 11, 2012 (DE) 102012209703.1

(51) Int. Cl. F15B 21/04

(52) U.S. Cl. CPC F15B 21/041
USPC 210/132; 210/130

(57) ABSTRACT

A reservoir for a hydraulic system includes a housing having an inlet and an outlet. The inlet is adapted to receive an incoming fluid and is formed within an inlet tube that extends into the housing. A filter within the housing, includes a filter element, defining an inner filter chamber, and includes an inlet opening encompassing the inlet tube that extends into the housing. The inlet opening allows the incoming fluid to enter the inner filter chamber for filtration. A base wall around the inlet opening includes a guide step that guides a relative movement between the reservoir and the filter. A relative movement between the filter and the reservoir facilitates the base wall, the guide step, and the inlet tube, to co-operate and establish a bypass route for selectively allowing the incoming fluid to bypass the filter, depending upon a predetermined differential pressure between the inlet and the outlet.

### BACKGROUND

This application generally relates to filters in hydraulic systems of vehicular steering units, and, more particularly, toward the application of a reservoir in those filtering systems.

For fault free and long-life operation of automotive vehicle steering systems, hydraulic systems employed within the steering systems, need to be maintained with utmost care. More specifically, care needs to be taken to ensure an appropriate filtering and separation of solid contaminants from the hydraulic systems, as presence of contaminants in a working fluid may affect the fluid's flow, such as by causing unwanted pressure and/or temperature fluctuations. Filters are thus installed into hydraulic systems to clear the hydraulic flow of impurities. Most often, filters applicable in such hydraulic systems are structured to have the smallest possible mesh size, allowing the element to filter and separate the smallest of impurities. Such small sized filters are also known as fine filters.

After a period of use however, fine filters generally become clogged by contaminants, in turn increasing the flow resistance and thus hampering effective filter operation. In addition, low ambient temperatures typically cause an increase in viscosity, further increasing the flow resistance. Alongside a resulting noisy filter operation, an increase in the flow resistance may result in a reduced fluid supply to the hydraulic system. If encountered, such a situation may even lead to an undue increase in the differential pressure applied across the filter, which may damage the filter by causing it to spilt.

To counter these conditions, bypass mechanism or valves have been developed to provide an alternate flow path to an incoming fluid, thereby ensuring an adequate supply of hydraulic fluid to the system. However, even though the fluid supply and the pressure variations are controlled through such a provision, bypass routes impose a serious drawback because they do not adequately prevent debris and contaminants, trapped in the filter, from being drawn back into the hydraulic system.

Oil filters are known to include non-return valves that prevent fluid flow in an opposite direction through the filter. Solutions also exist to bypass an oil separator in air compressors upon the breach of a specific value of the differential pressure across the air compressor. Such solutions work through a displacement of the oil separator against a spring to establish a bypass route for the air to travel post the oil separator, from an inlet to an outlet, owning to an increased air pressure build up.

No solution however exists that prevents the debris, contaminants, and trapped fluid impurities, from flowing back into the mainstream fluid flow, once the bypass route is established.

### SUMMARY

One aspect of the present disclosure describes a reservoir for a hydraulic system. The reservoir includes a housing with an inlet and an outlet. The inlet, which is formed through an inlet tube extending into the housing, is adapted to receive an incoming fluid. A filter basket is disposed within the housing and includes a filter element that defines an inner filter chamber. Further, the filter basket includes an inlet opening that encompasses the inlet tube extending into the housing and allows the incoming fluid to enter the inner filter chamber to be filtered. A base wall is structured around the inlet opening, and has a guide step to guide a relative movement between the reservoir and the filter basket. A relative movement between the filter basket and the reservoir facilitates the base wall, the guide step, and the inlet tube, to cooperate and establish a bypass route for selectively allowing the incoming fluid to bypass the filter basket depending upon a predetermined differential pressure between the inlet and the outlet of the reservoir.

Certain aspects of the present disclosure describe a hydraulic system reservoir that includes a housing with an inlet for receiving an incoming fluid, and an outlet. Structurally, the inlet is formed through an inlet tube that extends into the housing. A filter basket is arranged within the housing and includes a filter element that defines an inner filter chamber. An inlet opening is configured within the filter basket, which encompasses the inlet tube that extends into the housing. The inlet opening is adapted to receive the incoming fluid into the inner filter chamber for filtration. Moreover, a base wall is structured around the inlet opening, and has a guide step to guide a relative movement between the reservoir and the filter basket. Here, a relative movement between the filter basket and the reservoir facilitates the base wall, the guide step, and the inlet tube, to cooperate and establish a bypass route for selectively allowing the incoming fluid to bypass the filter basket depending upon a predetermined differential pressure between the inlet and the outlet of the reservoir. Additionally, at least one slosh baffle is provided on the base wall that defines a dead flow zone facilitating a restriction to trapped contaminants to remain within the filter basket.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 is a cross-sectional side view of a reservoir in a first operating state, according to the aspects of the present disclosure.

FIG. 2 is a cross-sectional side view of the reservoir of FIG. 1 in a second operating state.

FIG. 3 is a cross-sectional side view of another embodiment of the reservoir of FIG. 1, according to the aspects of the present disclosure.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure describes a reservoir employed within a hydraulic system of a vehicular steering system, configured to filter an amount of incoming fluid via a filter basket arranged between the reservoir's inlet and outlet. To this end, the filter basket includes a base wall surrounding the filter basket's inlet opening, a peripheral wall section, and central wall section. A slosh baffle connects the peripheral wall section to the central wall section. Depending upon a differential pressure between the inlet and the outlet of the reservoir during a fluid flow, the filter basket, assisted by a spring, may displace relative to the reservoir such that a bypass channel is opened between the inlet and the outlet. While such a bypass channel is created, the slosh baffle prevents contaminants and debris trapped in the filter from escaping back into the fluid flow.

### Exemplary Embodiments

As noted above, hydraulic system filters may become clogged by trapped contaminants. A bypass valve could divert fluid around the filter, maintaining fluid in the system, but that valve may inadvertently allow trapped contaminants to escape back into the hydraulic system. To confront such conditions, embodiments within the present disclosure disclose a slosh baffle structured within a filter basket. More particularly, the embodiments within the present disclosure disclose an arrangement where such a filter basket is positioned or housed within a reservoir, details and variations of which are discussed below.

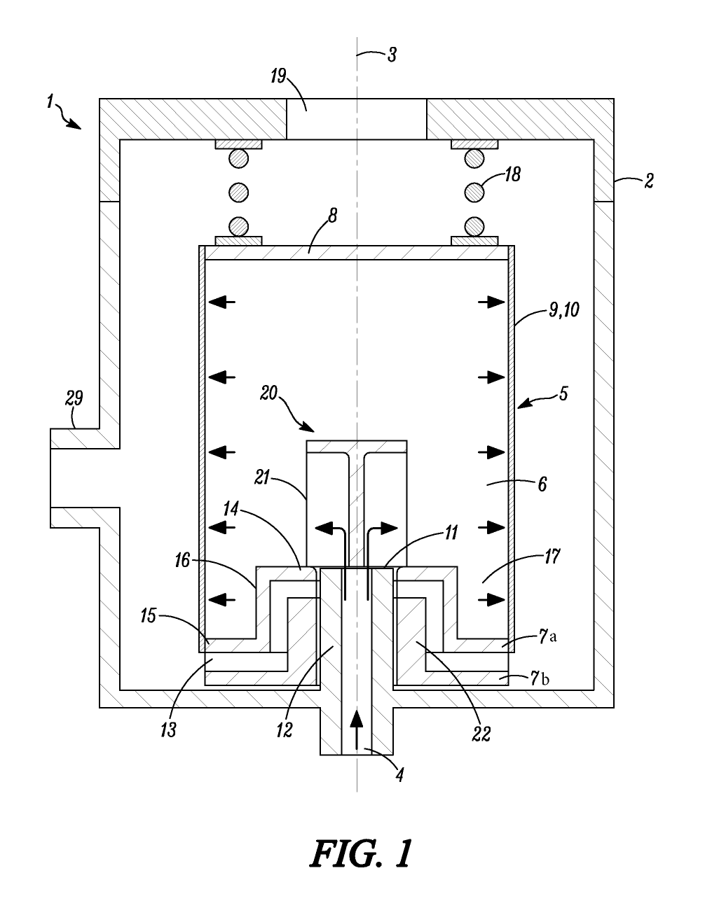

According to the present disclosure thus, FIG. 1 is an exemplary cross-sectional view of a reservoir 1. The reservoir 1 may be employed within a hydraulic system (not shown) of an exemplary steering system within a vehicle. The state of the reservoir 1 shown in FIG. 1 depicts a first operating position, which is a normal operating state.

Structurally, the reservoir 1 is substantially cylindrical in construction, and includes an inside chamber, referred to as a housing 2. Though a cylindrical shape is disclosed here, other reservoir shapes may be contemplated. Both the reservoir 1 and the housing 2 define a common longitudinal axis 3. An inlet 4, co-axial with the reservoir 1, receives an incoming hydraulic fluid. Correspondingly, an outlet 29 discharges a filtered fluid back into the hydraulic system. The housing 2 also includes a filler opening 19 through its top surface, as shown, for hydraulic fluid replenishment.

An inlet tube 12, having a suitable width, extends through this the housing 2, defining the inlet 4. The inlet tube 12 may be rigid structure permanently mounted to the reservoir 1 to establish an intake port for the fluid. On the outside, a relatively small extension of the inlet tube 12 may form a guide and/or a station for the reservoir 1 to be assembled and connected to the hydraulic system. A similar feature may be noted at the outlet 29 as well. Even though the present disclosure describes a cylindrically shaped inlet tube 12, those in the art may contemplate varied shapes and configurations. An extension of the inlet tube 12 into the housing 2 may be up to a level that allows the reservoir 1 to interact with the components housed with the housing 2. Those components and their interactions are discussed further below.

Accordingly, at least one filter basket 5 is mounted within the housing 2, between the inlet 4 and the outlet 29, for separating solid particles, debris, contaminants, and impurities from the incoming hydraulic fluid. Filter basket 5 includes a base wall, (“base 7”), a top wall 8, opposite to the base 7, and a side wall 9, which extends between base 7 and top wall 8. These elements surround and define an inner filter chamber 6. Preferably, the filter basket 5 is cylindrical in form.

The reservoir's top cap (not shown) may be removable, and thus, may aid in removing and assembling the filter basket 5 within the reservoir 1. More particularly, the filter basket 5 is positioned coaxial with the axis 3. As noted above, reservoir 1 is generally cylindrical in form as well, and reservoir 1 and filter basket 5 are designed for convenient mating engagement with one another. Additionally, the filter basket 5 includes an inlet opening 11 that substantially encompasses and sits flush with the top of inlet tube 12. More particularly, that inlet opening 11 is mated in a fluid-tight manner around the inlet tube 12. Thus, when filter basket 5 is assembled into the reservoir 1, a flow passage is established by which hydraulic fluid enters filter basket 5 through inlet 4, and flows into the inner filter chamber 6, and exits filter basket 5 through side wall 9, which filters the fluid. Alterations and variations to the filter basket's shape and its assembly to the reservoir 1, and other configurations, may be contemplated.

The side wall 9 is oriented substantially vertically, and is largely formed of a filter element, filter membrane 10. The filter membrane 10 is formed of a filter mesh designed to separate particles and contaminants from the fluid flow. In a preferred embodiment, the filter membrane 10 is a Nylon woven fabric having a mesh width ranging from 1 μm to wider mesh sizes. That mesh size allows those in the art to refer to filter membrane 10 as a fine filter. Other suitable materials for the filter membrane 10, such as polypropylene monofilament mesh, polyester felt, or similar materials, may also be employed. In some embodiments, the top wall 8 is formed of a similar filter membrane as well, substantially increasing the filtering regions within the filter basket 5. The filter membrane 10 may be assembled to the base 7 as a separate unit, attached by conventional fastening means, such as, snap fittings, threads, or locking mechanisms. Alternatively, the filter membrane 10 may be permanently attached, employing adhesives or the like.

For separating considerably larger particles from the hydraulic fluid, a coarse filter 20 is positioned over inlet opening 11 at the point where fluid enters the filter basket 5. The coarse filter 20 includes a cylindrical side wall 21, which is designed in a manner similar to a filter screen for separating off larger solid particles from the fluid stream. Therefore, the cylindrical side wall 21 may substantially be formed of a meshed structure as well, having a mesh width ranging from 1 μm to wider mesh sizes. A top wall of the coarse filter 20 may also include filtering capabilities.

Structurally, the coarse filter 20 is disposed coaxially with the inlet opening 11, and is attached to the base 7 through a snap fit, or a screw fit connection. Further, the coarse filter 20 substantially surrounds the inlet opening 11, so that the hydraulic fluid flowing in through the inlet 4, first passes through the coarse filter 20. Therefore, in an exemplary first operating position (as shown in FIG. 1) the filter membrane 10 and the coarse filter 20 are in effect connected in series, with the filter membrane 10 being arranged downstream from the coarse filter 20. Such an arrangement enables the coarse filter 20 to act as a pre-filter for the filter membrane 10, thus providing an additional protection to the filter membrane 10 against blockages and/or damages that may occur through larger contaminant particles.

Typically, fluid enters the inner filter chamber 6 through inlet 4 and exits through the side wall 9, leaving contaminant particles retained in the filter basket 5 by the filtering action of side wall 9. The particles initially lodge against the inner side of the side wall 9, but they eventually detach and fall to the bottom portion of the filter basket 5 by virtue of gravity.

The base 7 generally conforms to the cross section of filter basket 5, and thus this element is generally circular as in the illustrated embodiment. The detailed structure of base 7, however, consists of two layers, separated by a passage. An upper base layer 7a lies adjacent to the inner filter chamber 6, and its outer edge is attached to the lower end of side wall 9. Inner and outer horizontal portions 14, 15 lie transverse to the longitudinal axis of the reservoir 1, separated by a vertical portion, slosh baffle 16. In the illustrated embodiment, the horizontal portions are perpendicular to slosh baffle 16. An inlet opening 11 is formed in the center of base 7, and the upper and lower base layers 7a, 7b, extend from the inlet opening 11 to side wall 9.

A lower base layer 7b includes only two sections, a horizontal portion 7b extending to a position immediately below side wall 9, and step 22, which extends vertically along the inner surface of inlet opening 11. The upper and lower base layers 7a, 7b are separated from one another by passage 13, which opens onto central inlet 11 and its inner end and continues to open onto the interior of reservoir 1, outside the filter basket 5. In this manner, passage 13 provides a direct path from inlet opening 11 to the interior of reservoir 1, bypassing the interior of filter basket 5, and thus the filter element of sidewall 9.

Slosh baffle 16 lies parallel to sidewall 9, spaced from that wall by outer horizontal portion 15 of upper wall layer 7a. As a result, slosh baffle 16, outer horizontal portion 15, and sidewall 9 cooperate to define an annular dead flow zone 17 adjacent to the lower portion of sidewall 9. The reason for the label “dead flow zone” can be immediately appreciated when considering the flow pattern of fluid within inner filter chamber 6. There, fluid flows out of inlet opening 11 and then exits from filter basket 5 through the membrane 10 of sidewall 9, as indicated by arrows. Dead flow zone 17, however, lies below the level of inner horizontal portion 14 of upper wall layer 7a, and thus that volume of fluid is not impacted by the radially outward fluid flow pattern. Therefore, that annular volume is relatively stagnant.

In addition, dead flow zone 17 is ideally positioned to receive contaminant particles falling from the inner surface of sidewall 9. As noted above, the filtering action of sidewall 9 results in a quantity of contaminant particles being urged against the inner surface of sidewall 9 by the pressure exerted to normal fluid flow. When the fluid flow ceases, however, that pressure is removed, and gravity becomes the primary force acting upon the contaminant particles. Those particles descend, and the majority of those particles accumulate at the bottom of dead flow zone 17.

Slosh baffle 16 is positioned to effectively prevent the solid contaminants, deposited in the dead flow zone 17 over time, from being stirred up drawn back into the mainstream flow. In that manner, the structure of the present disclosure restricts and retains the sediments and trapped contaminants permanently within the filter basket 5.

In some embodiments, once a level of sediments has reached a predefined level, the filter basket 5 may be removed, cleansed of the deposited sediments, and assembled back into the hydraulic system. Certain embodiments may also include sensors placed within the filter basket 5 to signal the amount of impurities deposited, and/or when a limit is reached.

It will be noted that the multi-layer structure of bottom walls 7a and 7b provide a surface, elongated in the vertical direction, extending generally the length of inlet tube 12. Filter basket 5 is mounted for vertical sliding movement over inlet tube 12. Such movement is facilitated by step 22, structured into the base 7 below the slosh baffle 16, and adapted to guide relative movement between the two components. In combination with the horizontal portion of lower layer 7b, step 22 has an L-shaped cross sectional profile that complements the cross sectional profile of the slosh baffle 16, while fitted over the inlet tube 12. More specifically, the step 22 acts as a guide step or a guide bushing, by which the filter's base 7 is axially guided relative to the inlet tube 12, and thus, with the reservoir 1.

Thus, filter basket 5 is able to slide vertically within reservoir 1, and the particular vertical position assumed by filter basket 5 is governed by a spring 18. In a resting state, illustrated in FIG. 1, spring 18 biases filter basket 5 to a “full down” position, with the bottom of horizontal elements 7b bearing or resting on the inner surface of reservoir 1. As discussed more fully below, a number of resilient elements may be chosen to embody spring 18. In the illustrated embodiment of FIG. 1, spring 18 is a coil spring, formed from suitable spring steel and having a spring force suitable for carrying out the functions listed below. Those of ordinary skill in the art will understand that torsion springs, flat springs, and other types springs or resilient members, may be considered as well.

Spring 18 may be mounted to form a resilient interface between the filter basket 5 and the reservoir 1 by being attached to an inner seat of the housing 2, on one side, and by resting over the top wall 8, on its other side. In a normal operating state, as shown in FIG. 1, a predetermined amount of spring force pushes and retains the filter basket 5 towards the base 7, urging the filter basket 5 against the inlet 4, as shown. As can be seen in FIG. 1, that orientation results in passage 13 being blocked by inlet tube 12, and thus all of the incoming fluid is routed into the filter inner chamber 6 and then outward through filter membrane 10 of sidewall 9.

When incoming fluid is no longer able to flow freely through filter membrane 10, due either to clogging by contaminants or by increased fluid viscosity, pressure within the filter inner chamber 6 increases, which in turn increases the pressure exerted within inlet 4. That increase in differential pressure value across the filter basket 5 in turn results in an upward reactive force applied by the filter basket 5. When that reactive force becomes sufficient to overcome the downward force applied by the spring 18, the filter basket 5 depresses the spring 18, and thus moves upwards. The disclosure below sets out further details and features of those operational arrangements.

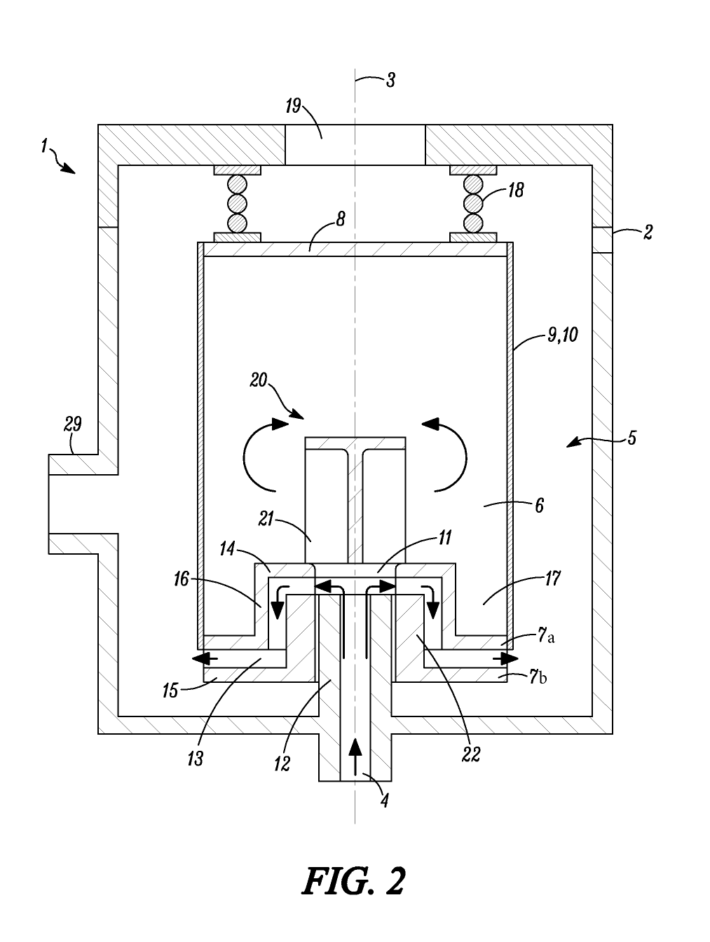

Turning to FIG. 2, a second operating position of the reservoir 1 is shown, in which a bypass path is opened. In particular, the bypass opens when differential pressure between the inlet 4 and outlet 29 increases beyond a predetermined threshold value. Pressure variations as noted, are generally caused by reduced flow rate, which in turn is an affected by several factors, including filter clogging and reduced ambient temperature. Whatever the cause, reduced flow beyond a certain point may starve the particular hydraulic system of fluid, which can endanger the vehicle and its occupants.

As explained above, an increase in internal pressure causes the filter basket 5 to depress the spring 18 and thus move upward, as shown in FIG. 2. As that upward motion occurs, step 22 ensures a secure axial guidance of the filter basket 5. As filter basket 5 moves further upward, the opening of passage 13 rises above the end of inlet tube 12, opening that passage for fluid flow. The path through passage 13 thus becomes the low-pressure route, completely bypassing the filter element of membrane 10 carried on sidewall 9. This bypass action ensures that the downstream hydraulic system will maintain sufficient fluid to operate reliably.

Accordingly, the bypass channel 13 ensures an adequate supply of hydraulic fluid within the hydraulic system, and the slosh baffle 16 effectively prevents impurities within the filter basket 5 from being drawn back into the hydraulic system. Moreover, the bypass flow path avoids damage to the filter membrane 10 as well. Such damage may include, for example, filter splitting, which may result from the pressure building up behind a clogged filter membrane 10, particularly when the hydraulic fluid becomes relatively viscous at low temperatures.

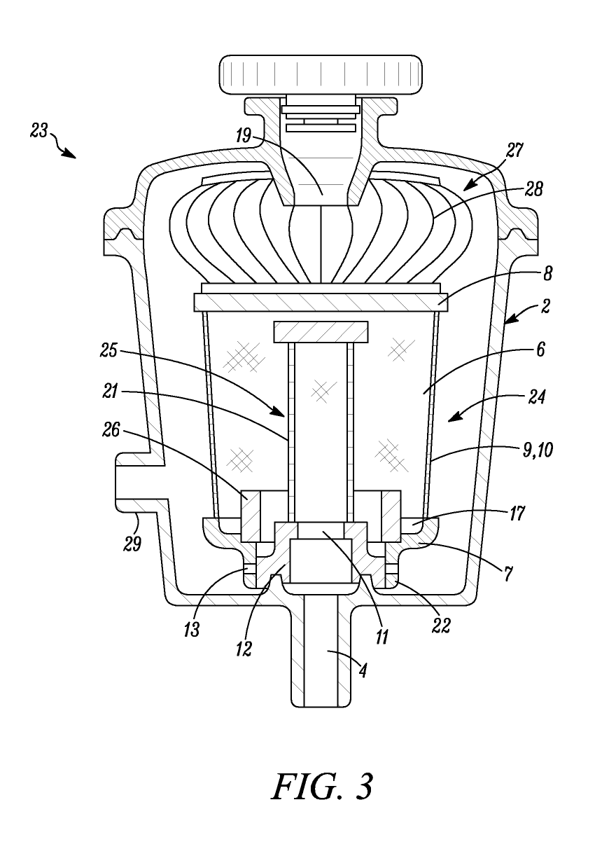

FIG. 3 is a cross sectional view of another embodiment of the present disclosure. Here, a reservoir 23 is depicted, the structural details of which remain generally similar to those discussed above. The reservoir 23 includes at least one filter 24 mounted between the inlet 4 and outlet 29 of the reservoir 23 for separating solid particles from a flowing hydraulic fluid. Similar to the filter basket 5 described above, the filter 24 may be formed substantially cylindrical, and may be symmetrical around its axis (not shown), and may include an inner filter chamber 6, as described above. Moreover, the filter 24 may include the side wall 9 in a configuration similar to the one already described, and may thus include the filter membrane 10, which may be a fine filter made of nylon fabric having a mesh size ranging from 1 μm to wider mesh sizes.

Also as discussed above, a coarse filter 25 may be connected in series to the filter membrane 10, disposed co-axially to the inlet opening 22, for screening and separating relatively larger sized impurities. The filter membrane 10 being arranged downstream of the fluid flow, allows the coarse filter 25 to encounter the hydraulic fluid first, during an exemplary flow, thus providing a pre-filtering stage for the hydraulic fluid.

Unlike the embodiment depicted in FIGS. 1 and 2, however, the coarse filter 25 is fixedly and co-axially connected to the inlet tube 12. Accordingly, the filter membrane 10 and the coarse filter 25 do not form a single fixedly interconnected structural unit as described above. Instead, only the filter membrane 10 is mounted in the housing 2 to be axially displaceable. Moreover, depending on the differential pressure between the inlet 4 and outlet 29 of the reservoir 23, the bypass channel 13 formed in the base 7 is designed to bypass the filter membrane 10 alone. In particular, when a differential pressure value breach is observed, the filter membrane 10 is lifted alone, leaving behind the coarse filter 20 as a stationery unit. The operating position of the reservoir 23 illustrated in FIG. 3 corresponds to the first operating position of the reservoir 1 illustrated in FIG. 1, in which the bypass channel 13 is closed.

The coarse filter 25 remains as part of a filtering stage in the second operation position as well, as discussed below, and thus, in both the operational positions, the hydraulic fluid flowing into the inner filter region 6 undergoes a stage of filtrations through the coarse filter 25. As a result, the sensitive fine filter (filter membrane 10) is effectively protected against damage from relatively large sized particles, and damages such as for example splitting, or that which may result from a high a differential pressure between the inlet 4 and outlet 29, may be avoided. Effectively, even when a fluid viscosity is relatively high, the hydraulic fluid still undergoes at least one filtration stage through the coarse filter 25.

In this embodiment, an additional wall element formed on the base 7, forms a slosh baffle 26, which is similarly disposed around the inlet opening 11. The slosh baffle 26 defines and forms a dead flow zone 17 on the base 7, in a manner similar to what has been described above. As described in the previous embodiments, the slosh baffle 26 too prevents impurities deposited in the dead flow zone 17 from being stirred up by a flow of hydraulic fluid, keeping them from scattering into other areas of the inner filter chamber 6, or from being drawn back into the hydraulic system. More particularly, the slosh baffle 26 prevents those impurities or sediments from escaping through the inlet opening 11 or the reservoir outlet 29 into the hydraulic system, when the bypass channel 13 is open.

Further, the reservoir 23 includes a resilient member or a spring element 27, which in this embodiment is an arc spring formed from several bending elements, referred to as members 28. In the depicted embodiment, the bending elements may be resilient metal strips, arrayed vertically around a central axis. In some embodiments, that arrangement may vary and may include the metal strips forming a circular profile, while some configurations may allow an elliptical profile formation. Other profiles may be contemplated as well. The metal strips have the requisite spring force to push and retain the filter 24 towards the inlet 4 depending upon the differential pressure across the filter 24. Moreover, the metal strips or the bending webs may be arranged closely next to one another in a suitable manner so that they achieve a desired screening action, preventing impurities to find their way into the reservoir 23 during fluid replenishment procedures. The profiles and the manner in which the metal strips form the member 28 may vary from application to application, and thus, the one depicted here should be viewed as being purely exemplary in nature. Accordingly, multiple methods and devices may be adopted to provide resilience at that reservoir-filter interface, which may be known and applied by someone skilled in the art. Alike above noted embodiments, fluid replenishment procedures are carried out through the filler opening 19. Additionally, the spring element 27 is disposed co-axially with the reservoir 23, and, more particularly, with the inlet 4.

Similar to what has already been described, one portion of the base wall 7 of the reservoir 23 is designed as a step 22, by which the base 7 is guided and retained axially to the inlet tube 12. Thus, a coaxial alignment of the inlet opening 11 relative to the inlet 4 or inlet tube 12 is established.

During operations, hydraulic fluid flows into the filter 24 first through the inlet 4 of the housing 2, and thereafter, through the inlet opening 11, to be received by the coarse filter 25. After passing through the coarse filter 25, the flow continues into the inner filter chamber 6, where the hydraulic fluid spreads out in the cylindrical-shaped filter 24 substantially radially symmetrically to all sides. Under normal operational conditions, when the fluid has sufficiently low viscosity and the filter membrane 10 is substantially free from clogging, the hydraulic fluid flows past the filter membrane 10 (side wall 9) with relative ease. The fluid thus exits the filter 24 and passes into the space surrounding the filter 24, which is defined by the housing 2. With the differential pressure across the filter 24 not being relatively high, the filter 24 retains its position and does not encounter a displacement. The bypass channel 13 thus remains closed.

When the differential pressure exceeds a predetermined threshold value, which can occur because of a relatively viscous fluid, owing to the lower operating temperatures, and/or because of substantial contamination, the filter membrane 10 is displaced axially upwards, releasing and providing the flowing fluid with at least a partial access to the bypass channel 13. Similar to the above embodiment, the base 7, the inlet tube 12, and the guide 22, co-operate to form the bypass channel. The inlet tube 12 in FIG. 3 however is different to what has been disclosed above, and forms an entity assembled to the bottom of the reservoir 23, as shown. In such a case, the hydraulic fluid flows from the inner filter chamber 6, through the annular volume 31 surrounding the lower portion of coarse filter 25, through passage 13 and thus into reservoir 23. This path bypasses the filter membrane 10 effectively. The hydraulic fluid however is still filtered by the coarse filter 25. Such an arrangement thus ensures that the hydraulic system is adequately supplied with hydraulic fluid even when the flow resistance is high. While a quantity of fluid is bypassed, the slosh baffle 26 holds the trapped contaminant particles in the filter through the dead flow zones 17, restricting them from flowing into the hydraulic system.

When applied in vehicles for a steering unit, the hydraulic fluid may be supplied from the reservoir 1, 23 to the hydraulic system, by way of a power steering pump. In one preferred embodiment, the reservoir 1 and 23 according to the present disclosure is used as a compensation tank for a hydraulic fluid in a hydraulic power steering unit of a motor vehicle.

The reservoirs 1, 23 according to the present disclosure are not limited to the disclosed embodiments, as those skilled in the art may ascertain multiple embodiments, variations, and alterations, to what has been described so far. Accordingly, none of the embodiments of the filtering systems disclosed in the application need to be viewed as being strictly restricted to the structure, configuration, and arrangement, described herein. Moreover, certain components described in the application may function independently of each other as well, and thus none of the implementations need to be seen as limiting in any way. It may be well known to those in the art that the description of the present disclosure may be applicable to a variety of other environments as well, and thus, the environment disclosed herein must be viewed as being purely exemplary in nature.

The specification has set out a number of specific exemplary embodiments, but those skilled in the art will understand that variations in these embodiments will naturally occur in the course of embodying the subject matter of the disclosure in specific implementations and environments. It will further be understood that such variations and others as well, fall within the scope of the disclosure. Neither those possible variations nor the specific examples set above are set out to limit the scope of the disclosure. Rather, the scope of claimed invention is defined solely by the claims set out below.

We claim:

1. A reservoir for a hydraulic system comprising:
a housing, having an inlet tube extending into the housing;
a filter basket disposed within the housing, the filter basket including
a filter element, generally cylindrical in form, defining an inner filter chamber, the filter basket being sized and positioned for sliding movement on the inlet tube,
a base wall, including
an upper base layer and a lower base layer, the base layers being spaced apart to define a bypass passage; and
resilient means mounted between the filter basket and the housing, having a spring force chosen to bias the filter basket between
a normal operating position, wherein the upper base layer blocks the bypass passage; and
a bypass operating position wherein the upper base layer does not block the bypass passage.

2. The reservoir of claim 1 further comprising at least one slosh baffle on the base wall, the slosh baffle spaced from the filter element to define a dead flow zone positioned to receive contaminants filtered from the fluid by the filter element and adapted to create a stagnant flow zone between the slosh baffle and the filter element.

3. The reservoir of claim 2, wherein the base wall has a central wall section disposed around the inlet opening and a peripheral wall section remote to the inlet opening, wherein the central wall section projects further into the inner filter chamber than the peripheral wall section, while the slosh baffle connects the central wall section to the peripheral wall section.

4. The reservoir of claim 1 wherein the resilient means is a spring element supported against an inner side of the housing, biasing the filter against the inlet, wherein the filter is mounted movably along an axis of the housing therein, such that:

5. The reservoir of claim 5, wherein the spring element is an arc spring formed from a plurality of bending elements.

6. The reservoir of claim 5 further comprising a filler opening in the housing along which the spring element is disposed co-axially.

7. The reservoir of claim 1, wherein the base wall includes
an inlet opening formed centrally on the base wall, sized and dimensioned for sliding vertical movement on the inlet tube, the length of the inlet opening being generally equal to that of the inlet tube; and
wherein
the upper base layer has an inner horizontal portion extending radially from the inlet opening, a vertical portion extending vertically downward from the outer end of the inner horizontal portion; and an outer horizontal portion extending radially outward from the lower end of the vertical portion, the outer end of the outer horizontal portion being attached to the lower end of the filter element;
the lower base layer has a vertical portion forming the inner surface of the inlet opening, extending vertically below the filter element, and a horizontal portion extending to a point below the end of the upper base layer outer horizontal portion;

8. The reservoir of claim 1, wherein the filter includes fine filter and a coarse filter connected in series, the fine filter being downstream from the coarse filter.

9. The reservoir of claim 8, wherein the bypass channel bypasses the fine filter but does not bypass the coarse filter.

10. The reservoir of claim 8, wherein the bypass channel bypasses both the coarse filter and the fine filter.

11. A reservoir for a hydraulic system comprising:
a housing, having an inlet tube extending into the housing;
a filter basket disposed within the housing, the filter basket including
a filter element, generally cylindrical in form, defining an inner filter chamber,
a base wall, including
a slosh baffle, spaced from the filter element to define a dead flow zone, positioned to receive contaminants filtered from the fluid by the filter element, and adapted to create a stagnant flow zone between the slosh baffle and the filter element;
an inlet opening formed centrally on the base wall, sized and dimensioned for sliding vertical movement on the inlet tube, the length of the inlet opening being generally equal to that of the inlet tube;
an upper base layer having an inner horizontal portion extending radially from the inlet opening, a vertical portion extending vertically downward from the outer end of the inner horizontal portion; and an outer horizontal portion extending radially outward from the lower end of the vertical portion, the outer end of the outer horizontal portion being attached to the lower end of the filter element;
a lower base layer having a vertical portion forming the inner surface of the inlet opening, extending vertically below the filter element, and a horizontal portion extending to a point below the end of the upper base layer outer horizontal portion;
wherein the lower base layer is separated from the upper base layer, defining a bypass passage between the lower base layer and the upper base layer;
resilient means for vertically biasing the filter basket, mounted between the upper portion of the filter basket and the inner surface of the housing, having a spring force chosen to bias between a normal operating position, wherein
the normal operating position bias is sufficient to position the filter basket such that the upper base layer blocks the bypass passage; and
the bypass operating position bias allows the filter basket to ascend to a position such that the upper base layer is above the bypass passage.

12. The reservoir of claim 11, wherein the slosh baffle is disposed concentrically around the inlet opening.

13. The reservoir of claim 11, wherein the base wall has a central wall section disposed around the inlet opening and a peripheral wall section remote to the inlet opening, wherein the central wall section projects further into the inner filter chamber than the peripheral wall section, while the slosh baffle connects the central wall section to the peripheral wall section.

14. The reservoir of claim 11 wherein the resilient means is a spring element supported against an inner side of the housing, biasing the filter against the inlet, wherein the filter is mounted movably along an axis of the housing therein, such that:

15. The reservoir of claim 14, wherein the spring element is an arc spring formed from a plurality of bending elements.

16. The reservoir of claim 14 further comprising a filler opening in the housing.

17. The reservoir of claim 11, wherein the filter includes a fine filter and a coarse filter connected in series, wherein the fine filter is disposed downstream from the coarse filter.

18. The reservoir of claim 17, wherein the bypass channel bypasses the fine filter.

19. The reservoir of claim 17, wherein the bypass channel bypasses both the coarse filter and the fine filter.
